(19) United States
(12) Patent Application Publication
(10) Pub. No.: US 2015/0234678 A1
(43) Pub. Date: Aug. 20, 2015

(54) CONTROLLING METHOD AND ELECTRONIC DEVICE FOR PROCESSING METHOD

(71) Applicant: Samsung Electronics Co., Ltd., Suwon-si (KR)

(72) Inventors: Ji-Hoon KIM, Suwon-si (KR); Jong-Cheul PARK, Suwon-si (KR)

(21) Appl. No.: 14/620,614

(22) Filed: Feb. 12, 2015

(30) Foreign Application Priority Data
Feb. 18, 2014 (KR) 10-2014-0018562

(51) Int. Cl. G06F 9/48

(52) U.S. Cl. CPC G06F 9/4843

(57) ABSTRACT

A method and an apparatus for controlling an electronic device are provided. The method includes driving a plurality of Operating Systems (OSs) controlling different mode states of the electronic device. A first OS among the plurality of OSs is set such that the first OS is executed in a first mode state. A second OS among the plurality of OSs is set such that the second OS is executed in a second mode state. While the first mode state is executed by the first OS, a control item executable by the second OS is displayed in the first mode state. In response to receiving an input relating to the control item, a control action corresponding to the control item is performed under the second mode state.

### CROSS-REFERENCE TO RELATED APPLICATION(S)

This application claims the benefit under 35 U.S.C. §119(a) of a Korean patent application filed on Feb. 18, 2014 in the Korean Intellectual Property Office and assigned Serial number 10-2014-0018562, the entire disclosure of which is hereby incorporated by reference.

### TECHNICAL FIELD

The present disclosure relates to an electronic device. More particularly, the present disclosure relates to a controlling method of an electronic device having a plurality of Operating Systems (OS), and the electronic device.

### BACKGROUND

Recently, electronic devices performing one or more functions complexly increase gradually. Furthermore, a mobile terminal generally characterized as a so-called ‘smartphone’ has been widely adopted by users. A mobile terminal has a large-sized touch type display module and has a mega pixel-camera module besides a basic function of communication with a counterpart user to perform still image shooting or moving picture shooting. According to various embodiments of the present disclosure, the mobile terminal may reproduce multimedia content such as music, a moving picture, and/or the like, and access a network to perform web surfing. According the related art, such mobile terminals may perform various functions faster by having a high performance processor gradually.

Generally, the electronic device may operate using an Operating System (OS) such as, for example, a Windows Mobile-based OS, an Android OS, an iPhone OS, a symbian OS, a black berry OS, and/or the like.

In addition, the electronic device may process an operation (e.g., application execution, or the like) corresponding to each OS using a plurality of different OSs.

The above information is presented as background information only to assist with an understanding of the present disclosure. No determination has been made, and no assertion is made, as to whether any of the above might be applicable as prior art with regard to the present disclosure.

### SUMMARY

An operating system (OS) may operate in a first mode or a second mode. The first mode may be a mode that outputs an operation of the OS in a foreground mode, and the second mode may be a mode that outputs an operation of the OS in a background mode. According to various embodiments, the foreground mode may be a state that occupies a display of the electronic device.

According to a related art, an electronic device may process an operation corresponding to each OS using a plurality of different OSs, and selectively activate at least one OS or simultaneously active a plurality of OSs and then control the same. For example, simultaneously activating a plurality of OSs means that the electronic device may operate at least one OS, for example, a first OS in a first mode, and operate the other OS, for example, a second OS in a second mode while driving the first OS and the second OS.

In the plurality of OSs having simultaneously activated different modes, it was difficult for an OS in the first mode to control an OS of the second mode according to the related art. In other words, to control the second OS that operates in the second mode in the first OS that operates in the first mode, the electronic device was able to control the second OS after changing the first OS to the second mode and changing the second OS to the first mode.

Aspects of the present disclosure are to address at least the above-mentioned problems and/or disadvantages and to provide at least the advantages described below. Accordingly, an aspect of the present disclosure is to provide a controlling method of an electronic device having a plurality of OS, and the electronic device.

In accordance with an aspect of the present disclosure, a method for controlling an electronic device is provided. The method includes executing a plurality of OSs, executing at least one first OS that operates in a first mode among the OSs, displaying a control item for at least second OS that operates in a second mode among the OSs, or controlling the second OS that operates in the second mode in response to an input.

In accordance with an aspect of the present disclosure, an electronic device is provided. The electronic device includes a memory configured to store a first OS or a second OS, a first OS management module configured to control the first OS, a second OS management module configured to control the second OS, and a module configured to generate and display a control item for the first OS or the second OS, and to change setting of the first OS or the second OS in response to an input.

In accordance with another aspect of the present disclosure, a computer-readable recording medium including a program recorded thereon is provided. The program may include operations of executing a plurality of OSs, executing at least one first OS that operates in a first mode among the OSs, displaying a control item for at least one second OS that operates in a second mode among the OSs on the first OS, and controlling the second OS that operates in the second mode in response to an input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a view illustrating a network environment including an electronic device according to various embodiments of the present disclosure;

FIG. 2 is a block diagram illustrating configuration of a control module according to various embodiments of the present disclosure;

FIG. 3 is a flowchart illustrating an operation of an electronic device according to various embodiments of the present disclosure;

FIG. 4 is a flowchart illustrating an operation of controlling an electronic device according to various embodiments of the present disclosure;

FIG. 5 is a flowchart illustrating an operation of controlling an electronic device according to various embodiments of the present disclosure;

FIG. 6 is a flowchart illustrating an operation of switching an Operating System (OS) of an electronic device according to various embodiments of the present disclosure;

FIGS. 7A, 7B, and 7C are views illustrating a circumstance that outputs a control item in an electronic device according to various embodiments of the present disclosure;

FIGS. 8A, 8B, 8C, and 8D are views illustrating an operation of switching an OS of an electronic device according to various embodiments of the present disclosure;

FIGS. 9A, 9B, and 9C are views illustrating an operation of controlling an electronic device according to various embodiments of the present disclosure;

FIGS. 10A, 10B, and 10C are views illustrating an operation of controlling an electronic device according to various embodiments of the present disclosure;

FIGS. 11A and 11B are views illustrating an operation of controlling an electronic device according to various embodiments of the present disclosure;

FIGS. 12A, 12B, and 12C are views illustrating an operation of controlling an electronic device according to various embodiments of the present disclosure; and

FIG. 13 is a block diagram illustrating an electronic device according to various embodiments of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Expressions such as “include” or “may include”, etc. that may be used for the present disclosure indicate existence of a disclosed relevant function, operation, or element, etc., and do not limit additional one or more functions, operations, or elements, etc. In addition, it should be understood that terminologies such as “include” or “have”, etc. in the present disclosure are intended for designating existence of a characteristic, a number, an operation, an element, a part, or a combination of these described on the specification and do not exclude in advance existence or addition possibility of one or more other characteristics, numbers, operations, elements, parts, or a combination of these.

Expression such as “or”, etc. in the present disclosure includes a certain and all combinations of words listed together. For example, “A or B” may include A and may include B, or include both A and B.

In the present disclosure, expressions such as “1st”, “2nd”, “first” or “second”, etc. may modify various elements of the present disclosure but do not limit relevant elements. For example, the expressions do not limit sequence and/or importance, etc. of relevant elements. The expressions may be used for discriminating one element from another element. For example, both a first user apparatus and a second user apparatus are all user apparatuses, and represent different user apparatuses. For example, a first element may be named as a second element without departing from the scope of the present disclosure, and similarly, the second element may be named as the first element.

When it is mentioned that a certain element is “connected to” or “accesses” another element, one should understand that the element may be directly connected to another element or may directly access another element, but still another element may exist in the middle. In contrast, when a certain element is mentioned “directly connected to” or “directly accesses” another element, one should understand that still another element does not exist in the middle.

A terminology used in the present disclosure is used for explaining only a specific embodiment and is not intended for limiting the present disclosure.

Unless defined differently, all terminologies used herein including technological or scientific terminologies have the same meaning as that generally understood by a person of ordinary skill in the art to which the present disclosure belongs. One should understand that generally used terminologies defined by a dictionary have meaning coinciding with meaning on context of a related technology, and unless clearly defined in the present disclosure, they are not understood as an ideal or excessively formal meaning.

An electronic device according to the present disclosure may be a device including a communication function. For example, an electronic device may include at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a mobile medical device, a camera, or a wearable device (e.g., a Head-Mounted-Device (HMD) such as electronic glasses, an electronic clothing, an electronic bracelet, an electronic necklace, an electronic appcessory, an electronic tattoo, or a smartwatch).

According to certain various embodiments, an electronic device may be a smart home appliance having a communication function. A smart home appliance may include, for example, at least one of a television (TV), a Digital Video Disk (DVD) player, an audio, a refrigerator, an air conditioner, a cleaner, an oven, an electronic range, a washing machine, an air purifier, a set-top box, a TV box (e.g., Samsung HomeSync™, Apple TV™, or Google TV™), game consoles, an electronic dictionary, an electronic key, a camcorder, or an electronic frame.

According to certain various embodiments, an electronic device may include at least one of various medical devices (e.g., Magnetic Resonance Angiography (MRA), Magnetic Resonance Imaging (MRI), Computed Tomography (CT), a shooting device, an ultrasonic device, etc.), a navigation device, a Global Positioning System (GPS) receiver, an Event Data Recorder (EDR), a flight data recorder (FDR), an automobile infotainment device, electronic equipment for a ship (e.g., a navigation device for a ship, a gyro compass, and/or the like), an avionics, a security device, or a robot for an industrial use or a home use.

According to certain various embodiments, an electronic device may include at least one of a furniture or a portion of a building/structure including a communication function, an electronic board, an electronic signature receiving device, a projector, or various measurement devices (e.g., waterworks, electricity, gas, or radio wave measuring device, and/or the like). An electronic device according to the present disclosure may be a combination of one or more of the above-described devices. In addition, it is obvious to a person of ordinary skill in the art that the electronic device according to the present disclosure is not limited to the above-described devices.

Hereinafter, an electronic device according to various embodiments of the present disclosure is described with reference to the accompanying drawings. A terminology of a user used in various embodiments may indicate a person who uses an electronic device or a device (e.g., an artificial intelligence electronic device) that uses the electronic device.

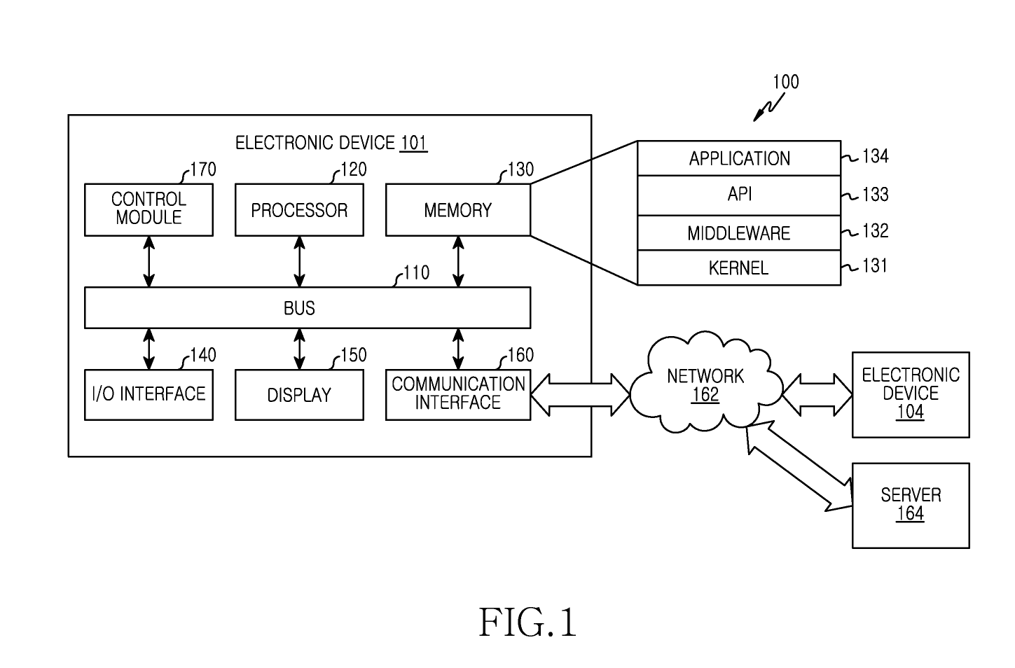

FIG. 1 is a view illustrating a network environment including an electronic device according to various embodiments of the present disclosure.

Referring to FIG. 1, a network environment 100 including an electronic device 101 is provided. The electronic device 101 may include a bus 110, a processor 120, a memory 130, an input/output (I/O) interface 140, a display 150, a communication interface 160, and a control module 170.

The bus 110 may be a circuit for connecting the above-described elements with each other, and transferring communication (e.g., a control message) between the above-described elements.

The processor 120 may receive, for example, an instruction from the above-described other elements (e.g., the memory 130, the I/O interface 140, the display 150, the communication interface 160, or the control module 170, and/or the like) via the bus 110, decipher the received instruction, and execute an operation or a data process corresponding to the deciphered instruction.

The memory 130 may store an instruction or data received from the processor 120 or other elements (e.g., the I/O interface 140, the display 150, the communication interface 160, the control module 170, and/or the like), or generated by the processor 120 or other elements. The memory 130 may include, for example, programming modules such as a kernel 131, a middleware 132, an Application Programming Interface (API) 133, or an application 134. The each of the programming modules may be configured using a software, a firmware, a hardware, or a combination of two or more of these.

The kernel 131 may control or manage system resources (e.g., the bus 110, the processor 120, the memory 130, and/or the like) used for executing an operation or a function implemented in the rest of the programming modules, for example, the middleware 132, the API 133, or the application 134. According to various embodiments of the present disclosure, the kernel 131 may provide an interface for allowing the middleware 132, the API 133, or the application 134 to access an individual element of the electronic device 101 and control or manage the same.

The middleware 132 may perform a mediation role so that the API 133 or the application 134 may communicate with the kernel 131 to give and take data. According to various embodiments of the present disclosure, in connection with task requests received from the applications 134, the middleware 132 may perform a control (e.g., scheduling or load balancing) for a task request using, for example, a method of assigning priority that may use a system resource (e.g., the bus 110, the processor 120, the memory 130, and/or the like) of the electronic device 101 to at least one of the applications 134.

The API 133 is an interface for allowing the application 134 to control a function provided by the kernel 131 or the middleware 132, and may include at least one interface or function (e.g., an instruction) for file control, window control, image processing, character control, and/or the like.

According to various embodiments, the application 134 may include an Short Message Service (SMS)/Multimedia Messaging Service (MMS) application, an e-mail application, a calendar application, alarm application, a health care application (e.g., an application for measuring quantity of motion, blood sugar, and/or the like), or an environment information application (e.g., an application providing atmospheric pressure, humidity or temperature information, etc.). Additionally or alternatively, the application 134 may be an application related to information exchange between the electronic device 101 and an external electronic device (e.g., the electronic device 104). The application related to the information exchange may include, for example, a notification relay application for transferring specific information to the external electronic device or a device management application for managing the external electronic device.

For example, the notification relay application may include a function for transferring notification information generated from a different application (e.g., a Short Messaging Service (SMS)/Multimedia Messaging Service (MMS) application, an e-mail application, a health care application, an environment information application, and/or the like) of the electronic device 101 to an external electronic device (e.g., the electronic device 104). Additionally or alternatively, the notification relay application may, for example, receive notification information from an external electronic device (e.g., the electronic device 104) and provide the same to a user. The device management application may manage (e.g., install, delete, or update) a function (e.g., turn-on/turn-off of an external electronic device itself (or some constituent part) or luminance (or resolution) control of a display) of an external electronic device (e.g., the electronic device 104) communicating with the electronic device 101 and an application operating in the external electronic device or a service (e.g., a communication service or a message service) provided by the external electronic device.

According to various embodiments of the present disclosure, the application 134 may include a designated application depending on an attribute (e.g., a kind of an electronic device) of the external electronic device (e.g., the electronic device 104). For example, in the case according to which the external electronic device is an MP3 player, the application 134 may include an application related to music reproduction. Similarly, in the case according to which the external electronic device is a mobile medical health care device, the application 134 may include an application related to health care. According to an embodiment of the present disclosure, the application 134 may include at least one of an application designated in the electronic device 101 and an application received from the external electronic device (e.g., the server 106 or the electronic device 104).

The I/O interface 140 may transfer an instruction or data input from a user via an I/O unit (e.g., a sensor, a keyboard, or a touchscreen) to the processor 120, the memory 130, the communication interface 160, or the control module 170 via the bus 110, for example. As an example, the I/O interface 140 may provide data regarding a user touch input via the touchscreen to the processor 120. According to various embodiments of the present disclosure, the I/O interface 140 may, for example, output an instruction or data received via the bus 110 from the processor 120, the memory 130, and the communication interface 160, or the control module 170 via the I/O unit (e.g., a speaker or a display). For example, the I/O interface 140 may output voice data processed by the processor 120 to a user via a speaker.

The display 150 may display various information (e.g., multimedia data or text data, etc.) to a user.

The communication interface 160 may connect communication between the electronic device 101 with an external device (e.g., the electronic device 104 or the server 106). For example, the communication interface 160 may be connected with a network 162 via wireless communication or wired communication to communicate with the external device. The wireless communication may, for example, include at least one of Wi-Fi, Bluetooth (BT), Near Field Communication (NFC), GPS, or cellular communication (e.g., Long Term Evolution (LTE), Long Term Evolution-Advanced (LTE-A), Code Division Multiple Access (CDMA), Wideband Code Division Multiple Access (WCDMA), Universal Mobile Telecommunications System (UMTS), Wireless Broadband (WiBro), or Global System for Mobile Communications (GSM), etc.). The wired communication may include, for example, at least one of Universal Serial Bus (USB), High Definition Multimedia Interface (HDMI), recommended standard 232 (RS-232), and Plain Old Telephone Service (POTS).

According to an embodiment of the present disclosure, the network 162 may be a telecommunications network. The telecommunications network may include at least one of a computer network, the Internet, an Internet of things, and a telephone network. According to an embodiment of the present disclosure, a protocol (e.g., a transport layer protocol, a data link layer protocol, or a physical layer protocol) for communication between the electronic device 101 and an external device may be supported by at least one of the application 134, the API 133, the middleware 132, the kernel 131, or the communication interface 160.

According to an embodiment of the present disclosure, the control module 170 may control, for example, a first Operating System (OS) or a second OS. According to an embodiment of the present disclosure, the control module 170 may control activation of an OS or control an operation mode of an activated OS. According to various embodiments of the present disclosure, the control module 170 may control the second OS under a circumstance where the first OS operates. According to an embodiment of the present disclosure, the control module 170 may change setting of the inactivated second OS with the first OS activated. According to an embodiment of the present disclosure, the control module 170 may change setting of the second OS that operates in a second mode (a background mode) while the first OS operates in a first mode (a foreground mode).

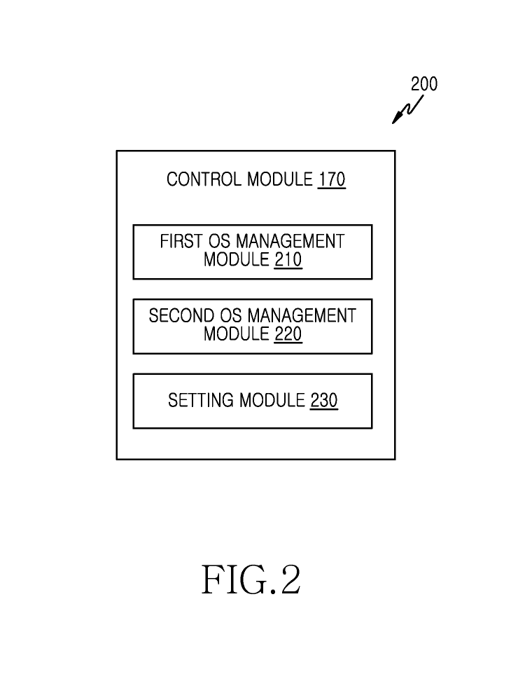

Additional information for the control module 170 is provided via FIGS. 2 to 13.

FIG. 2 is a block diagram illustrating configuration of a control module according to various embodiments of the present disclosure.

Referring to FIG. 2, the control module (e.g., the control module 170 of FIG. 1) may include a first OS management module 210, a second OS management module 220, a setting module 230, and/or the like.

The first OS management module 210 may control an operation of the first OS.

According to an embodiment of the present disclosure, the first OS management module 210 may activate or inactivate the first OS under control of a processor (e.g., the processor 120 of FIG. 1). According to another embodiment of the present disclosure, the first OS management module 210 may control an operation mode of the activated first OS under control of the processor 170. For example, the first OS management module 210 may allow the activated first OS to operate in a first mode or allow the first OS to operate in a second mode.

According to various embodiments of the present disclosure, the first OS management module 210 may manage setting information of the first OS. The setting information of the first OS may be a control item that may be controlled in the first OS. According to an embodiment of the present disclosure, the setting information may be an application, menu configuration, screen configuration, and/or the like that correspond to the first OS. The first OS management module 210 may manage the setting information using a markup language such as Hyper Text Markup Language (HTML), eXtensible Markup Language (XML), Vector Markup Language (VML), Procedure Graphic Markup Language (PGML), Scalable Vector Graphics (SVG), and/or the like. The control information may be shared with an OS management module (e.g., the second OS management module 220, the setting module 230) that manages another OS.

According to various embodiments of the present disclosure, the first OS management module 210 may also manage information for a control method (e.g., a numerical value input method, a bar control), a control range (e.g., a minimum range, a maximum range), and/or the like with respect to an item having a control range (e.g., an adjustment range such as a volume, vibration, a bell sound, and/or the like).

The second OS management module may perform an operation similar to an operation of the first OS management module 210. For example, the second OS management module 220 may activate or inactivate the second OS. For another example, the second OS management module 220 may process so that the second OS may operate in a first mode or a second mode. According to another embodiment of the present disclosure, the second OS management module 220 may manage setting information of the second OS.

The setting module 230 may manage setting of the second OS. According to an embodiment of the present disclosure, the setting module 230 may control the second OS under a circumstance where the first OS operates.

The setting module 230 may obtain setting information for each OS from the first OS management module 210 or the second OS management module 220 to generate a control item. According to an embodiment of the present disclosure, the setting module 230 may receive setting information of a markup language type managed by the first OS management module 210 or the second OS management module 220 to generate a control menu for the first OS or the second OS. According to an embodiment of the present disclosure, the setting module 230 may generate a control menu based on a control method, a control range, and/or the like provided from each OS management module.

The setting module 230 may control the first OS management module 210 or the second OS management module 220 so that each OS is controlled in response to a control input.

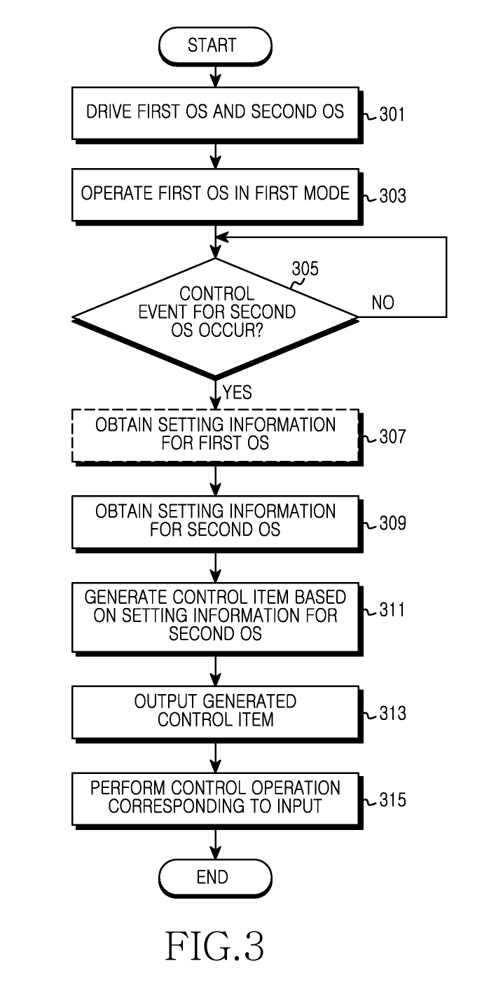

FIG. 3 is a flowchart illustrating an operation of an electronic device according to various embodiments of the present disclosure.

Referring to FIG. 3, the electronic device may drive a plurality of OSs. According to an embodiment of the present disclosure, the electronic device may operate at least one OS, for example, a first OS in a first mode, and operate the other OS, for example, a second OS in a second mode while driving the first OS and the second OS.

In operation 301, the electronic device may drive a plurality of OSs, for example, a first OS or a second OS. According to an embodiment of the present disclosure, the electronic device may drive a plurality of different OSs, and the OS may include a Window Mobile-based OS, an Android OS, an iPhone OS, a symbian OS, or a Black Berry OS, and/or the like.

In operation 303, the electronic device may operate the first OS in a first mode. The electronic device may operate the second OS in a second mode while operating the first OS in the first mode.

In operation 305, the electronic device may determine whether a control event for the second OS occurs. The control for the second OS may include controlling setting of the second OS. According to an embodiment of the present disclosure, the control event for the second OS may include controlling screen brightness setting, volume setting (e.g., a bell sound, a media volume, an alarm volume, and/or the like), communication mode setting (e.g., a cellular mode, a Wi-Fi mode, BT mode, a GPS mode, an NFC mode, and/or the like), execution of an application, and/or the like.

In operation 309, the electronic device may obtain setting information for the second OS. The setting information of the second OS may be a control item that may be controlled in the second OS.

In operation 311, the electronic device may generate a control item based on setting information for the second OS.

According to various embodiments of the present disclosure, the electronic device may generate a control item (e.g., a control menu) for brightness, a volume, a communication mode, and/or the like of the second OS.

Additionally, in operation 307, the electronic device may obtain setting information for the first OS. The setting information of the first OS may be a control item that may be controlled in the first OS. In this case, in operation 311, the electronic device may generate a control item for the first OS and a control item for the second OS. According to an embodiment of the present disclosure, the electronic device may generate a control item that may be controlled in each OS. According to an embodiment of the present disclosure, the electronic device may generate a control item that may be controlled equally by the first OS and the second OS. According to an embodiment of the present disclosure, the electronic device may generate a control item for a function communicating with a peripheral device, for example, a Wi-Fi, BT, an NFC function.

In operation 313, the electronic device may output the generated control item.

According to various embodiments of the present disclosure, the electronic device may output a control item for controlling the second OS while driving the first OS.

In operation 315, the electronic device may perform a control operation corresponding to an input.

Though FIG. 3 explains a method for controlling simultaneously driven OSs according to various embodiments of the present disclosure, the electronic device may detect an input to control a currently driven OS and control an OS not driven simultaneously. According to an embodiment of the present disclosure, in the case according to which a control event for the second OS occurs with only the first OS activated, the electronic device may activate an inactivated OS to perform a control operation corresponding to an input.

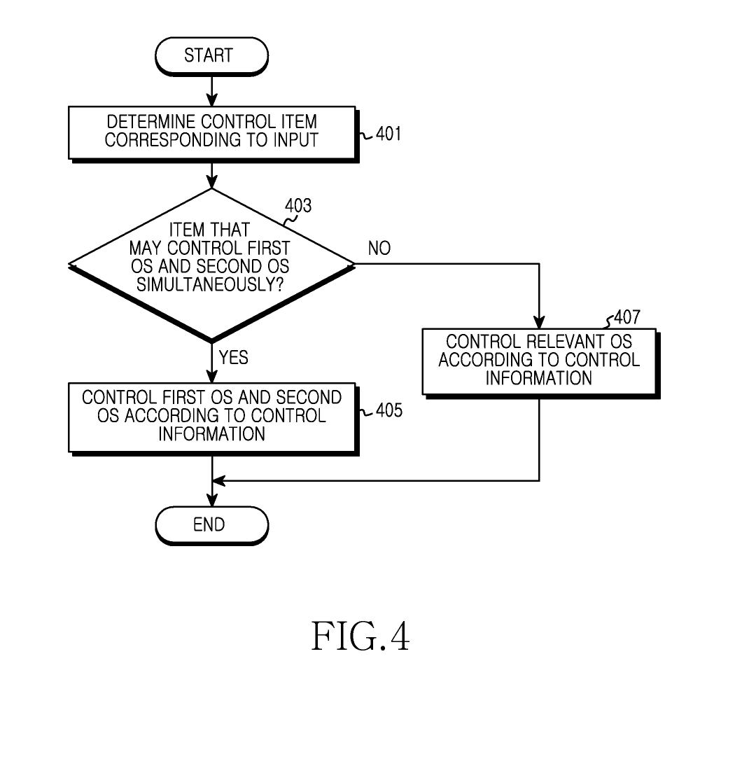

FIG. 4 is a flowchart illustrating an operation of controlling an electronic device according to various embodiments of the present disclosure.

Referring to FIG. 4, the electronic device may output a control item. For example, the electronic device may generate and output a control item based on the operation of FIG. 3.

In operation 401, the electronic device may determine a control item corresponding to an input. The electronic device that drives the first OS or the second OS may detect an input of selecting at least one of output control items while operating the first OS in a first mode. According to an embodiment of the present disclosure, the electronic device that drives the first OS in the first mode may execute an application for the first OS in a foreground, and execute an application for the second OS in a background.

In operation 403, the electronic device may determine whether a control item corresponding to an input is an item that may control the first OS and the second OS simultaneously.

In operation 405, in case of detecting a circumstance of controlling the first OS or the second OS, the electronic device may control the first OS and the second OS in response to an input.

In operation 407, in case of detecting a circumstance of controlling the first OS or the second OS, the electronic device may control an OS corresponding to an input, for example, the first OS or the second OS.

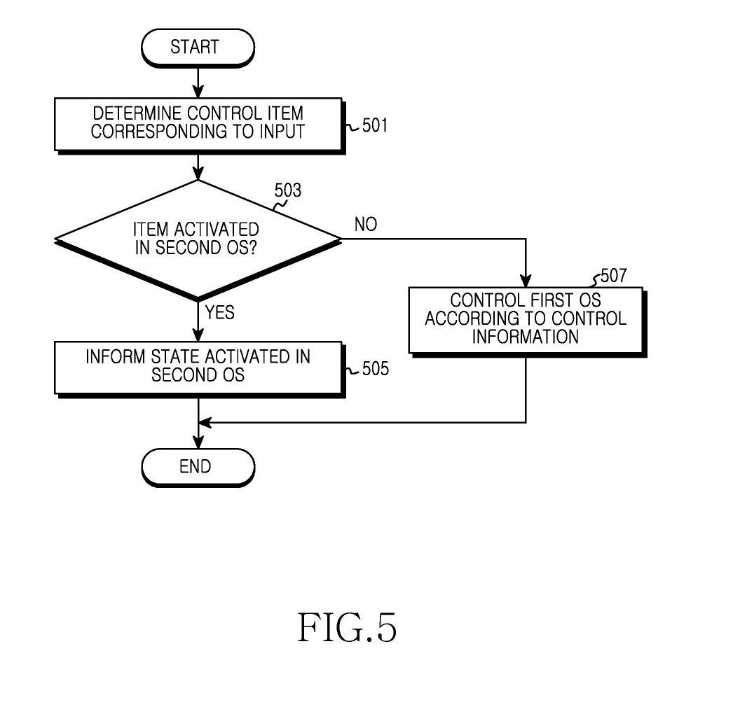

FIG. 5 is a flowchart illustrating an operation of controlling an electronic device according to various embodiments of the present disclosure. Description of a portion among descriptions related to FIG. 5 which is the same as or similar to FIG. 4 is omitted.

Referring to FIG. 5, according to various embodiments of the present disclosure, the electronic device may process such that a function communicating with a peripheral device, for example, a Wi-Fi, BT, an NFC function are controlled in only one OS.

In operation 501, the electronic device may determine a control item corresponding to an input. Operation 501 may be an operation that determines a control item selected by a user.

In operation 503, the electronic device may determine whether the control item corresponding to the input is an item activated in the second OS. According to an embodiment of the present disclosure, the control item corresponding to the input may be an item that activates Wi-Fi, BT, and NFC functions. At least one of these items may be activated via the second OS.

In operation 505, in case of detecting a circumstance of intending to control an item activated in the second OS, the electronic device may inform a state in which a control item corresponding to an input is activated in the second OS.

In operation 507, in case of detecting a circumstance of intending to control an item inactivated in the second OS, the electronic device may control the first OS in response to an input.

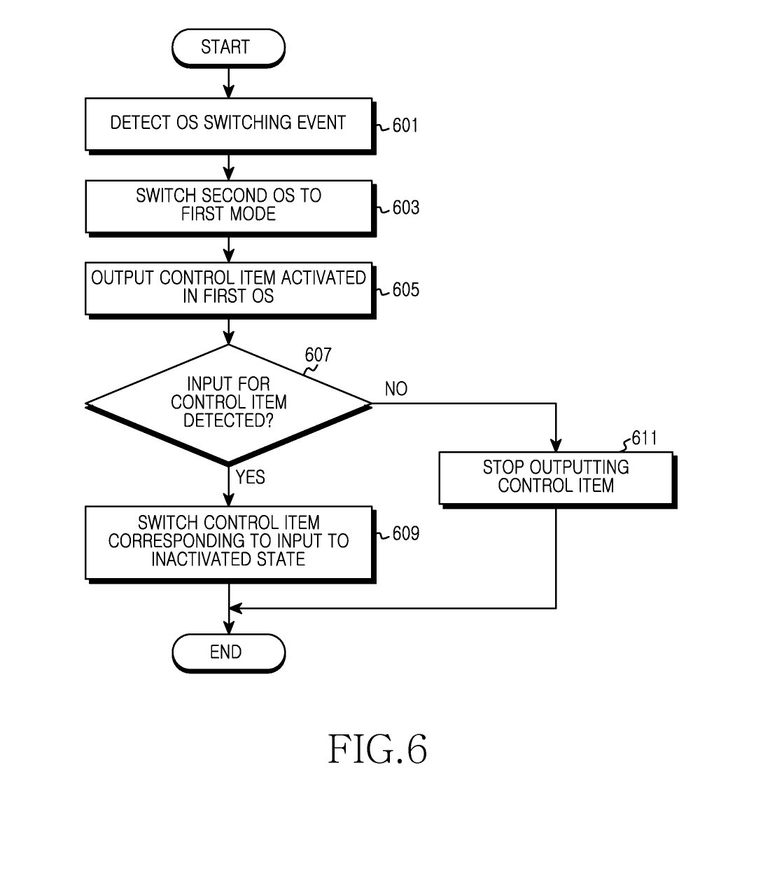

FIG. 6 is a flowchart illustrating an operation of switching an OS of an electronic device according to various embodiments of the present disclosure. Description of a portion among descriptions related to FIG. 6 which is the same as or similar to FIG. 4 is omitted.

Referring to FIG. 6, in operation 601, the electronic device may detect an OS switch event. The OS switching may be changing an operating mode of activated OSs, for example, changing the first OS that operates in a first mode to a second mode, and changing the second OS that operates in a second mode to a first mode.

In operation 603, the electronic device may switch the second OS to the first mode. According to an embodiment of the present disclosure, the electronic device may switch the first OS to the second mode, and then switch the second OS to the first mode.

In operation 605, the electronic device may output a control item whose state is activated in the first OS.

In operation 607, the electronic device may detect an input for a control item being output.

In operation 609, in case of detecting the input for the control item being output, the electronic device may switch the control item corresponding to the input to an inactivated state.

In operation 611, in the case according to which the input for the control item being output is not detected, the electronic device may stop outputting of the control item after a predetermined time defined in advance.

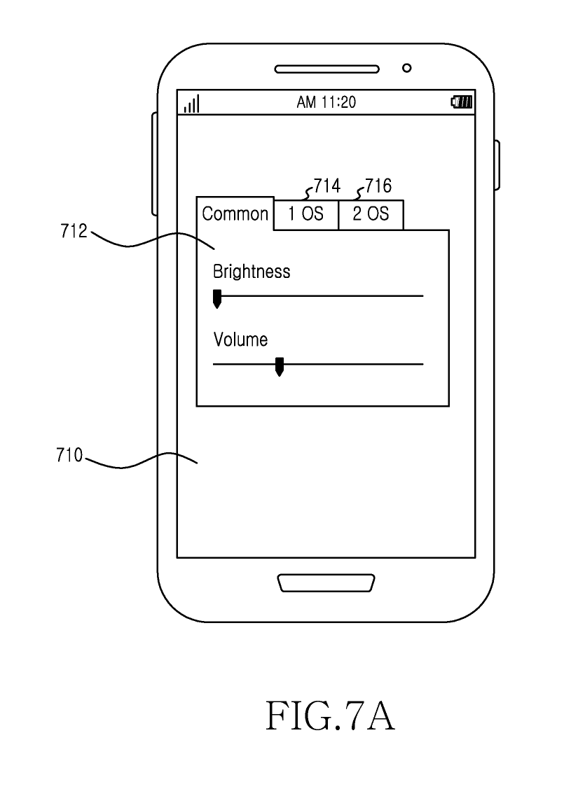

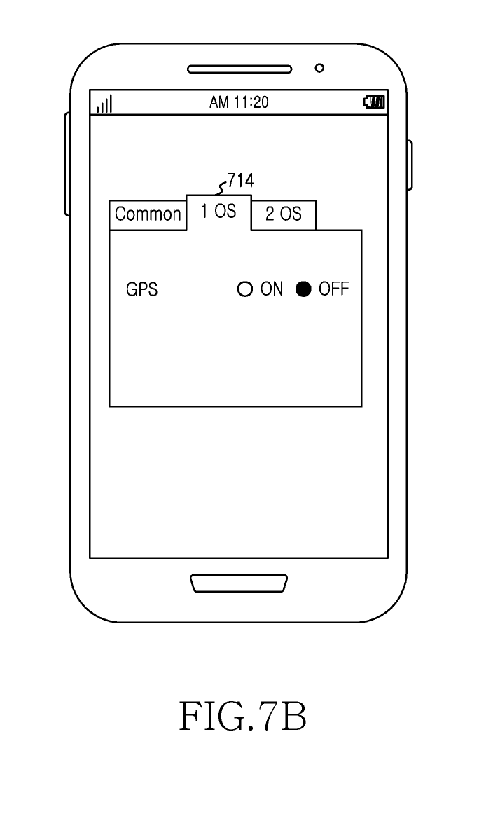

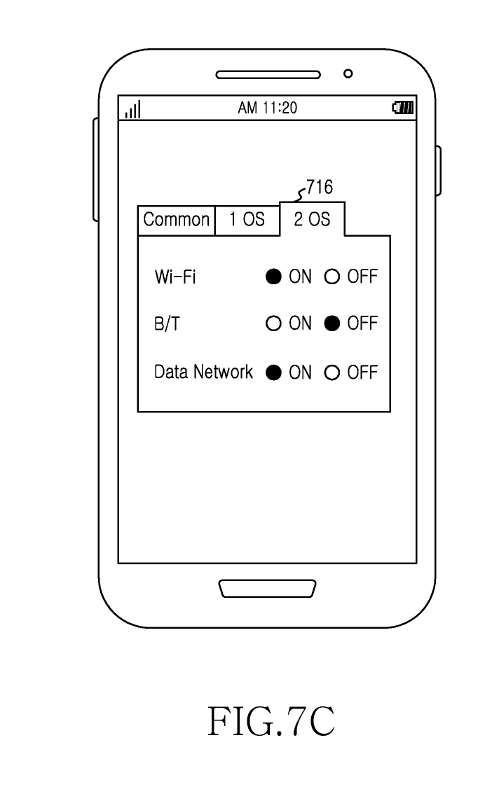

FIGS. 7A to 7C are views illustrating a circumstance that outputs a control item in an electronic device according to various embodiments of the present disclosure.

In case of detecting a control event while driving a plurality of OSs, the electronic device may generate and output a control item based on setting information of the first OS or the second OS. The control item is a control item that may be controlled in each OS, and may include an item for controlling volume setting, an item for setting screen brightness, a control item for a function for communicating with a peripheral device, for example, Wi-Fi, BT, and NFC functions, and/or the like.

Referring to FIGS. 7A to 7C, according to an embodiment of the present disclosure, the electronic device may output a control item 710 for the first OS or the second OS as illustrated in FIG. 7A.

FIGS. 7A to 7C illustrate a control item including an item 712 (e.g., common) that may be equally controlled in the first OS and the second OS, an item 714 (e.g., 1 OS) that may be controlled in the first OS, and an item 716 (e.g., 2 OS) that may be controlled in the second OS.

The item 712 (common) that may be equally controlled in the first OS and the second OS may be the same items among control items that may be controlled in the first OS and control items that may be controlled in the second OS, for example, screen brightness adjust item, a volume adjust item, and/or the like.

According to an embodiment of the present disclosure, the item (e.g., 1 OS) 714 that may be controlled in the first OS may include a control item that may be controlled in only the first OS, for example, a GPS control item as illustrated in FIG. 7B.

According to an embodiment of the present disclosure, the item (e.g., 2 OS) 716 that may be controlled in the second OS may include a control item that may be controlled in only the second OS, for example, a Wi-Fi control item, a BT control item, a data network control item, and/or the like as illustrated in FIG. 7C.

Though control items included in the common item are excluded from the items that may be controlled in the first OS or the second OS, the electronic device may include the items included in the common item in the item that may be controlled in the first OS or the second OS. For example, a brightness adjust item, a volume adjust item, or a GPS control item may be included in an item that may be controlled in the first OS.

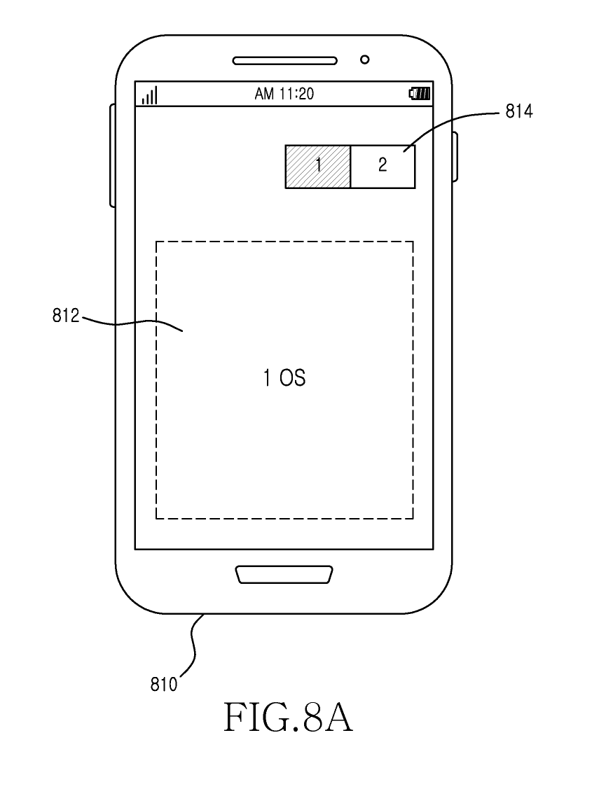

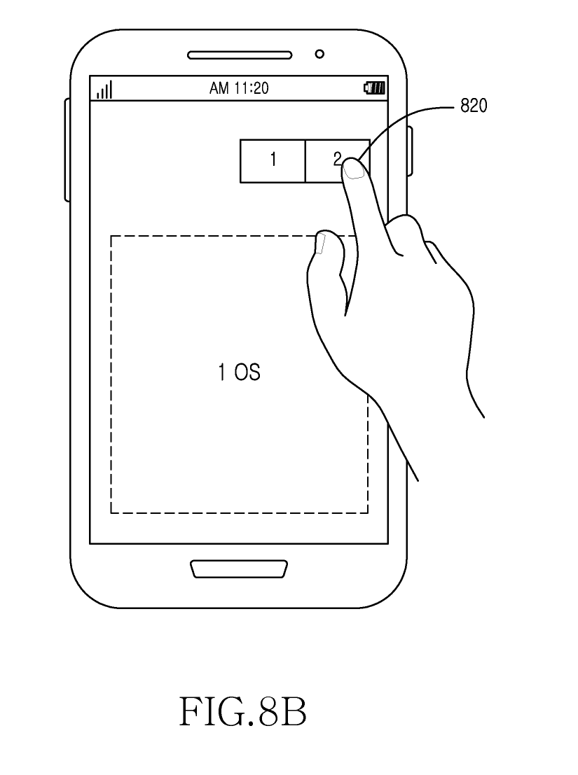

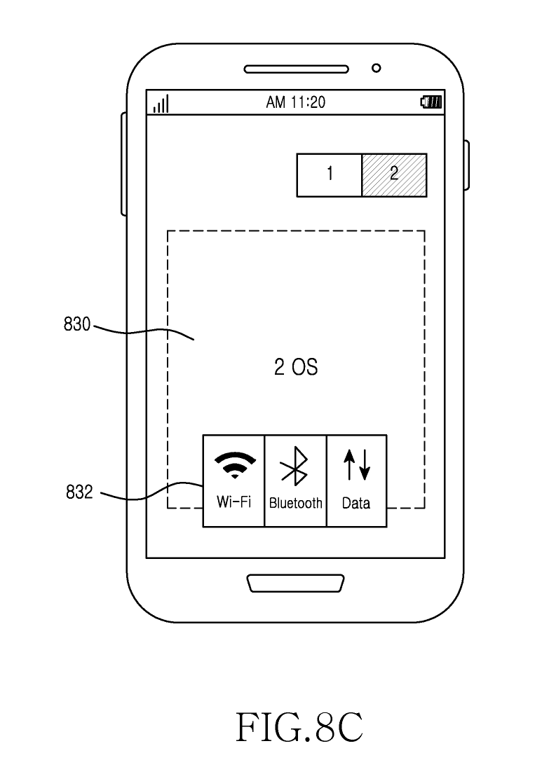

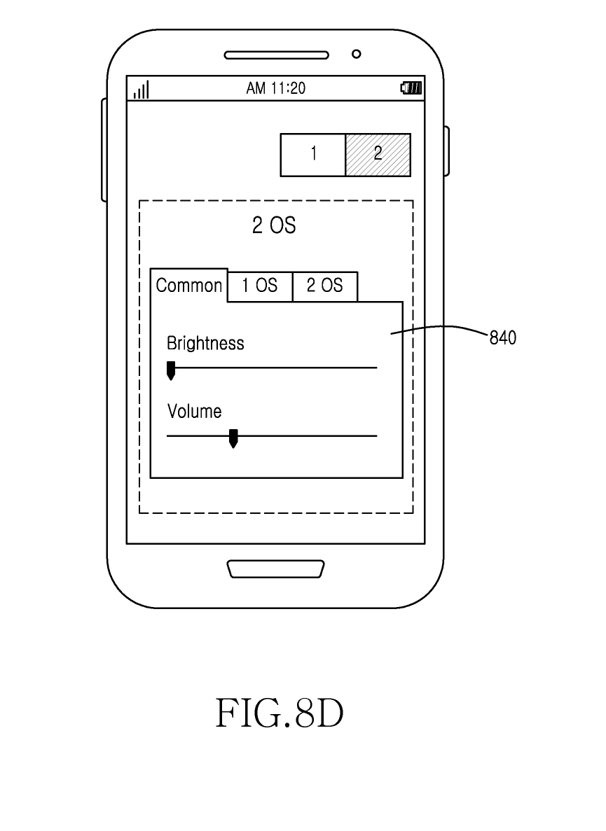

FIGS. 8A to 8D are views illustrating an operation of switching an OS of an electronic device according to various embodiments of the present disclosure.

Referring to FIGS. 8A to 8D, electronic device 810 may change an operation mode of activated OSs. For example, the electronic device that has driven a first OS and a second OS may operate the first OS in a first mode as illustrated in FIG. 8A. As illustrated, a function 812 (e.g., an associated image or application) that operates in the first OS may be output to the screen. In addition, a menu 814 for changing an operation mode of an OS may be included in the screen of the electronic device 810, and the first OS may operate in the first mode or the second OS may operate in the first mode depending on an input for the menu.

According to various embodiments of the present disclosure, a menu that may select an OS operating in the first mode may include an indicator for recognizing an OS operating in the first mode currently. According to an embodiment of the present disclosure, the indicator may be a color, a pattern (e.g., inclination, blinking, etc.), and/or the like. According to an embodiment of the present disclosure, expressing that the first OS currently operates in the first mode is possible by applying a shadow process to a menu that may select an OS operating in the first mode as illustrated.

An input 820 may be entered to the electronic device 810. For example, the input 820 may be entered for switching an OS operating in the first mode, for example, an input for allowing the second OS to operate in the first mode as illustrated in FIG. 8B, the OS operating in the first mode is switched as illustrated in FIG. 8C.

In the case according to which the second OS is switched to the first mode under a circumstance where the first OS operates in the first mode as illustrated in FIG. 8C, the electronic device may output an operation 830 (e.g., an image or application) of the second OS executed in a background to a foreground. In addition, an indicator for recognizing the OS operating in the first mode may display the second OS operates in the first mode.

According to various embodiments of the present disclosure, the electronic device may output a control item 832 corresponding to a circumstance where an operation of an OS is switched, for example, a control item (e.g., a user-defined item) defined in advance at a point at which the OS is switched. According to an embodiment of the present disclosure, the output control item 832 may include a control item for a function for communicating with a peripheral device, for example, Wi-Fi, BT, and data communication functions, and/or the like.

According to various embodiments of the present disclosure, the electronic device may detect an input for an output control item to control a relevant operation.

According to various embodiments of the present disclosure, in case of detecting an input defined in advance, the electronic device may output a control item 840 that may be controlled in the first OS or the second OS as illustrated in FIG. 8D. As illustrated, a user-defined screen may be changed to an entire control item.

According to various embodiments of the present disclosure, in the case according to which an input for a control item output is not detected for a predetermined time defined in advance, the electronic device may stop outputting of the control item.

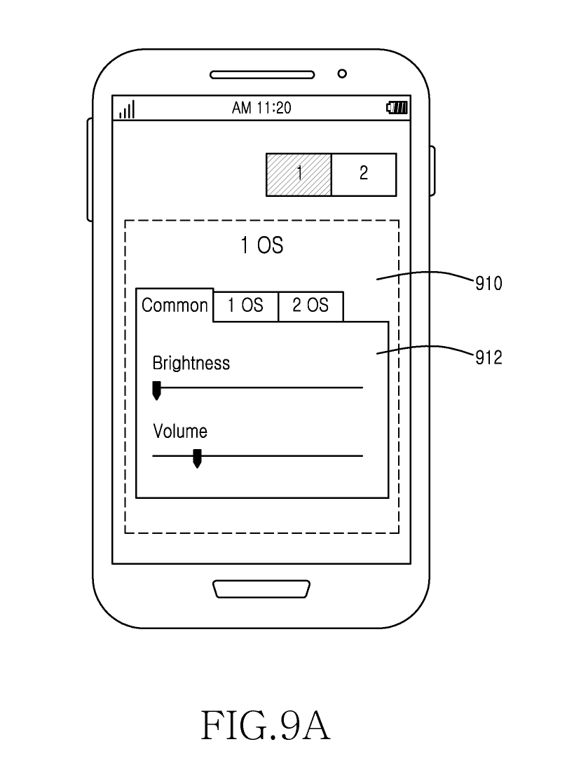

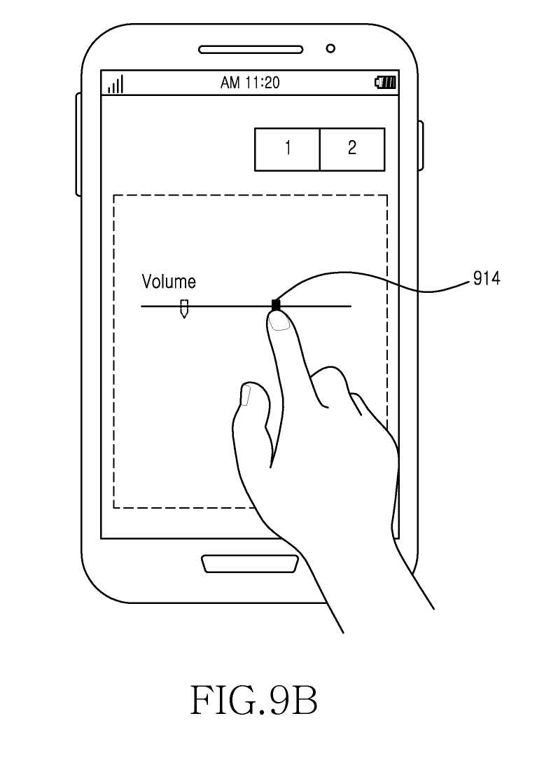

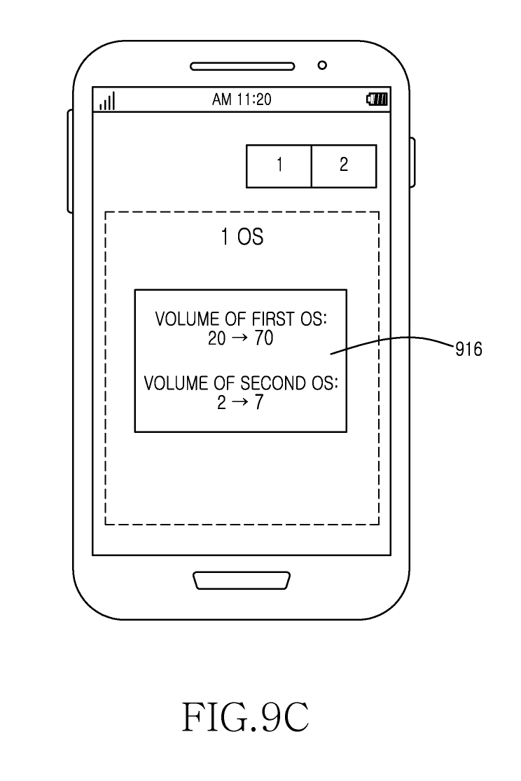

FIGS. 9A to 9C are views illustrating an operation of controlling an electronic device according to various embodiments of the present disclosure. Description of a portion among descriptions related to FIG. 9 which is the same as or similar to FIGS. 8A to 8D are omitted.

Referring to FIG. 9A, the electronic device may output a control item 912 under a state 910 where a first OS operates in a first mode.

The illustrated drawing illustrates a circumstance where control items that may be controlled in the first OS or the second OS are output with an operation of the first OS output.

Referring to FIG. 9B, the electronic device may detect a user input to control an operation of the first OS or a second OS. The illustrated drawing shows an operation of adjusting a volume.

The electronic device may adjust a volume set in advance to a volume corresponding to a user's input. Though a circumstance where the volume is adjusted to a large volume corresponding to a touch input is illustrated in the drawing, the electronic device may adjust the volume using a key button input, a voice input, a motion input, and/or the like.

Referring to FIG. 9C, an electronic device according to various embodiments of the present disclosure may adjust a volume of the first OS and a volume of the second OS simultaneously while operating the first OS in the first mode.

According to an embodiment of the present disclosure, the electronic device may adjust a volume of the second OS in the same manner as a volume of the first OS. For example, the volume of the first OS may be assumed to be adjustable in an adjustment range from a minimum 0 to a maximum 100, and the volume of the second OS is adjustable in an adjustment range from a minimum 0 to a maximum 10. Under this circumstance, in the case according to which the volume of the first OS is adjusted to 70 by an input, the electronic device may process such that the same level of a volume may be set by adjusting the volume of the second OS to 7.

In addition, the electronic device may output a result 916 controlled in the first OS and the second OS, for example, a volume adjustment result on the screen.

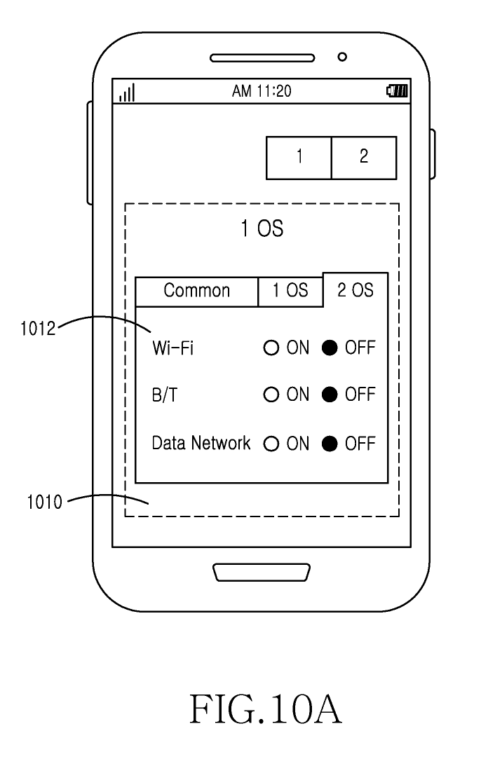

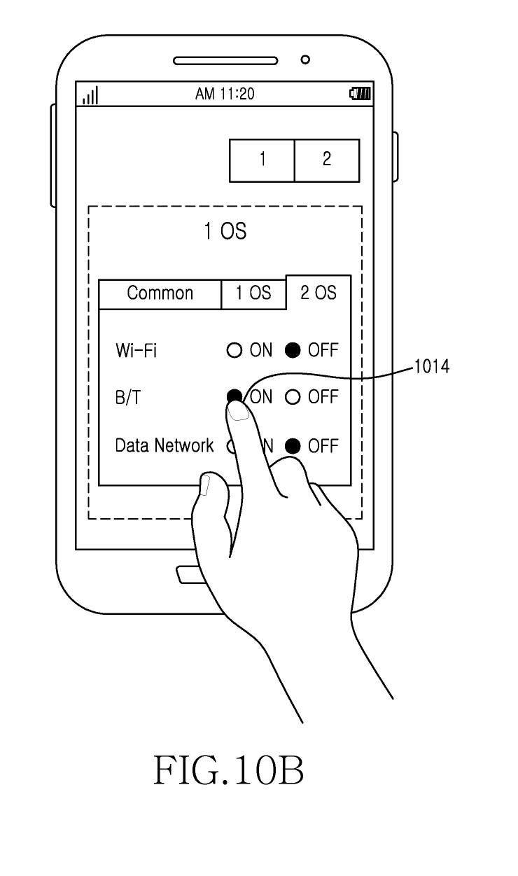

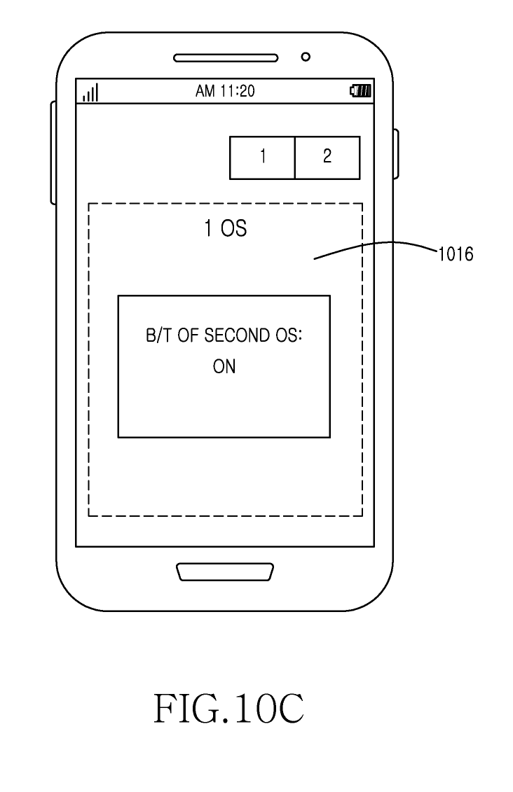

FIGS. 10A to 10C are views illustrating an operating of controlling an electronic device according to various embodiments of the present disclosure. Description of a portion among descriptions related to FIG. 10 which is the same as or similar to FIGS. 8A to 8D are omitted.

Referring to FIG. 10A, the electronic device may output a control item while operating a first OS in a first mode.

FIG. 10A illustrates a circumstance where a control item 1012 that may be controlled in a second OS is output under a state 1010 that outputs an operation of the first OS.

Referring to FIG. 10B, the electronic device may detect a user input to control a function of the second OS. The illustrated drawing shows an operation of activating a BT function of the second OS.

In case of detecting an input 1014 for activating a BT function of the inactivated second OS, the electronic device may activate the BT function of the second OS in response to an input under a circumstance 1016 where the first OS operates in the first mode as illustrated in FIG. 10C.

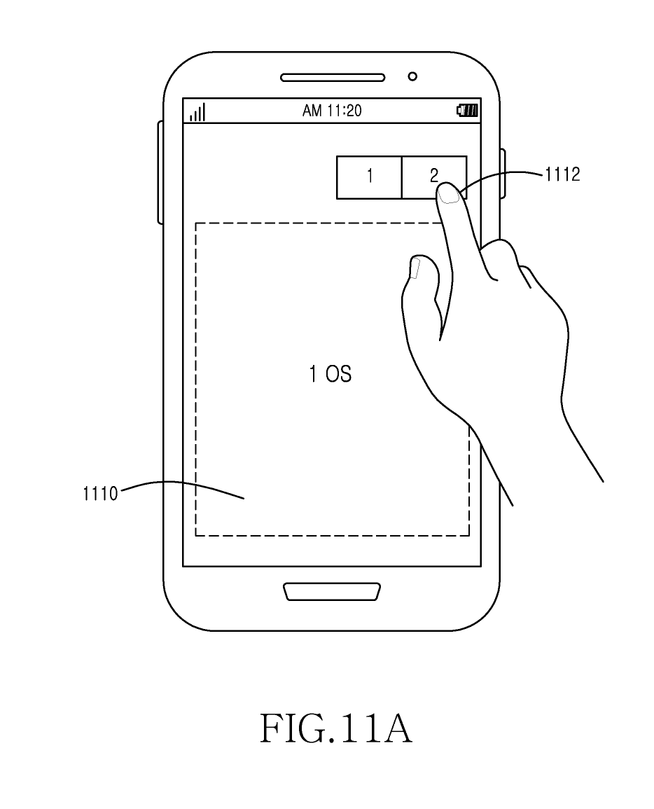

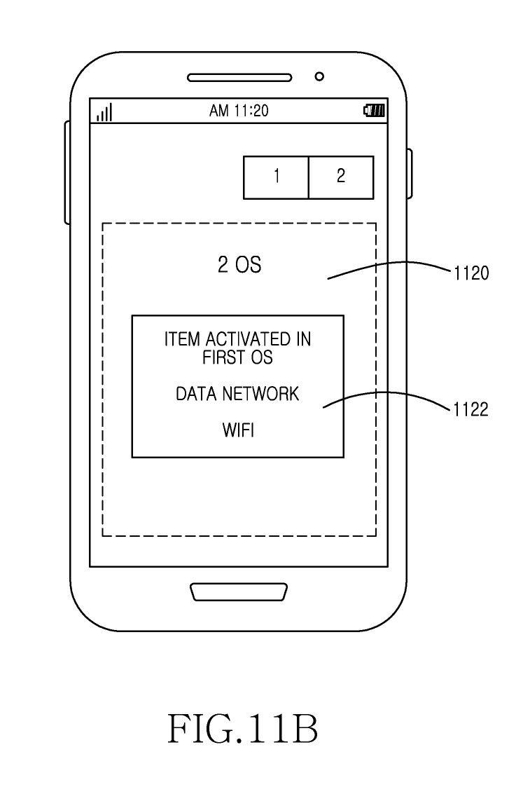

FIGS. 11A and 11B are views illustrating an operation of controlling an electronic device according to various embodiments of the present disclosure. Description of a portion among descriptions related to FIGS. 11A and 11B which are the same as or similar to FIGS. 8A to 8D are omitted.

Referring to FIG. 11A, the electronic device may detect an input 1112 of switching an operation of an OS under a state 1110 that has operated a first OS in a first mode. The illustrated drawing shows a circumstance where an input 112 that allows a second OS to operate in a first mode occurs.

Referring to FIG. 11B, the electronic device may process control item 1120 such that the second OS operates in the first mode in response to an input, and then output information 1122 for a function activated in the first OS.

The illustrated drawing illustrates a circumstance where the first OS informs a data network function and a Wi-Fi function have been activated at a point at which the second OS operates in the first mode.

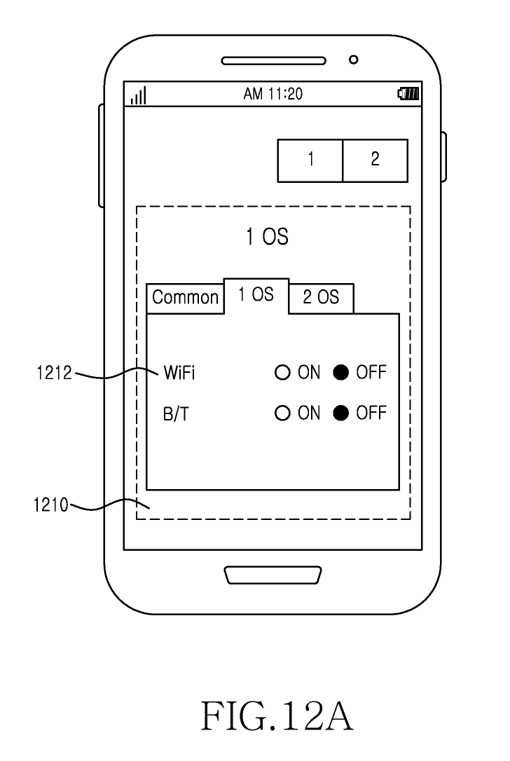

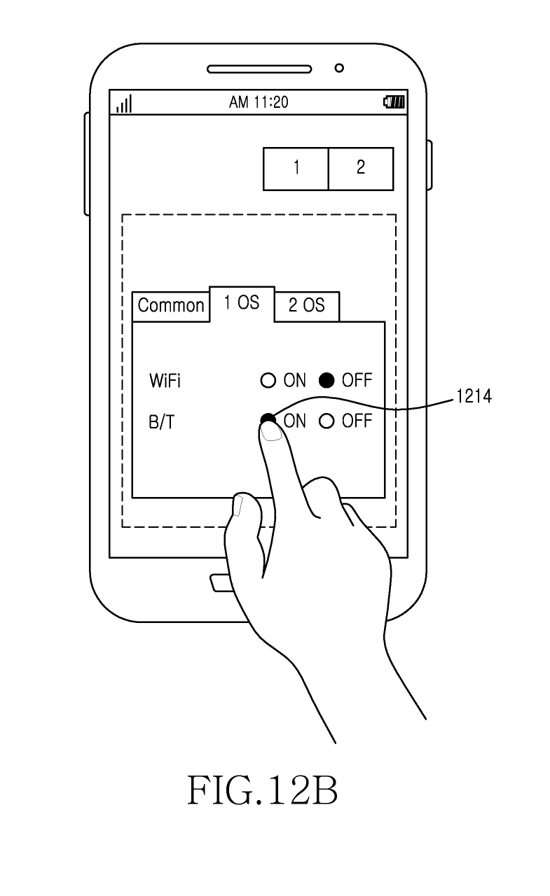

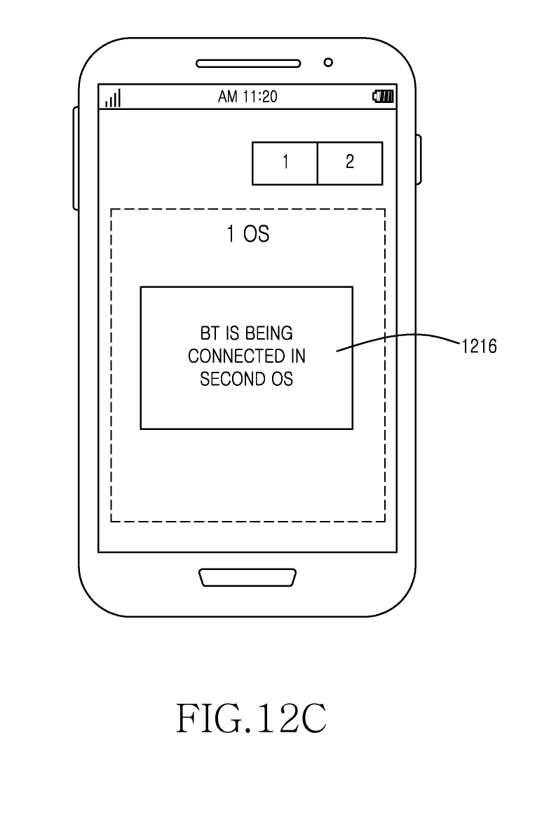

FIGS. 12A to 12C are views illustrating an operation of controlling an electronic device according to various embodiments of the present disclosure. Description of a portion among descriptions related to FIGS. 12A and 12B which are the same as or similar to FIGS. 8A to 8D are omitted.

Referring to FIG. 12A, the electronic device may output a control item 1212 that may be controlled in a first OS under a state 1210 that has operates the first OS in a first mode.

In case of detecting an input for a control item being output, the electronic device may determine whether a function corresponding to the input is in use in another OS.

Referring to FIG. 12B, according to various embodiments of the present disclosure, in case of detecting an input 1214 for activating a BT function of the first OS, the electronic device may determine whether the BT function is in use in a second OS.

In case of determining the function corresponding to the input is not in use in another OS, the electronic device may control the relevant operation in response to the input.

Referring to FIG. 12C, according to various embodiments of the present disclosure, in case of determining the function corresponding to the input is in use in another OS, the electronic device may output information 1216 informing the function corresponding to the input is in use in another OS.

According to various embodiments of the present disclosure, a method for controlling an electronic device may include driving a plurality of OSs controlling different mode states of the electronic device, setting a first OS among the plurality of OSs such that the first OS is executed in a first mode state, and setting a second OS among the plurality of OSs such that the second OS is executed in a second mode state, while the first mode state is executed by the first OS, displaying a control item executable by the second OS in the first mode state, and when receiving an input for the control item, performing a control action corresponding to the control item under the second mode state.

According to various embodiments of the present disclosure, the control item may be a control item that may be controlled in a relevant OS, and may include an item for controlling volume setting, an item for setting screen brightness, a function for communicating with a peripheral device, for example, a control item for Wi-Fi, BT, and NFC functions, and/or the like. According to various embodiments of the present disclosure, a control action corresponding to a control item may include changing setting for a relevant control item. For example, the control action may include an action for changing a set volume size, an action for activating or inactivating Wi-Fi, BT, and NFC functions, and/or the like.

According to various embodiments of the present disclosure, the first mode state may include a state that outputs one or more functions being executed via a display, and the second mode state may include a state that executes a function in a background.

According to various embodiments of the present disclosure, the first OS may include a Windows OS, and the second OS may include an Android OS.

According to various embodiments of the present disclosure, the method may include displaying, at the first OS, a control item that is executable in the second mode state in the first mode state. According to various embodiments of the present disclosure, the method may include displaying, at the second OS, a control item that is executable in the first mode state in the first mode state.

According to various embodiments of the present disclosure, the method may include, while the first mode state is executed by the first OS, displaying information for a function activated in the first OS and/or the second OS. According to various embodiments of the present disclosure, the method may include, in the case according to which the second OS operates in the first mode, displaying information for a function of the first OS activated in the first mode.

According to various embodiments of the present disclosure, performing the control action corresponding to the control item under the second mode state may include performing a control action corresponding to a control item corresponding to an input under even the first mode state.

According to various embodiments of the present disclosure, performing the control action corresponding to the control item under the second mode state may include determining whether a control item corresponding to an input is activated under the first mode state, and outputting the determination result.

According to various embodiments, the method may include, in the case according to which the second OS executed under the second mode state is executed in the first mode state, displaying a control item meeting a condition.

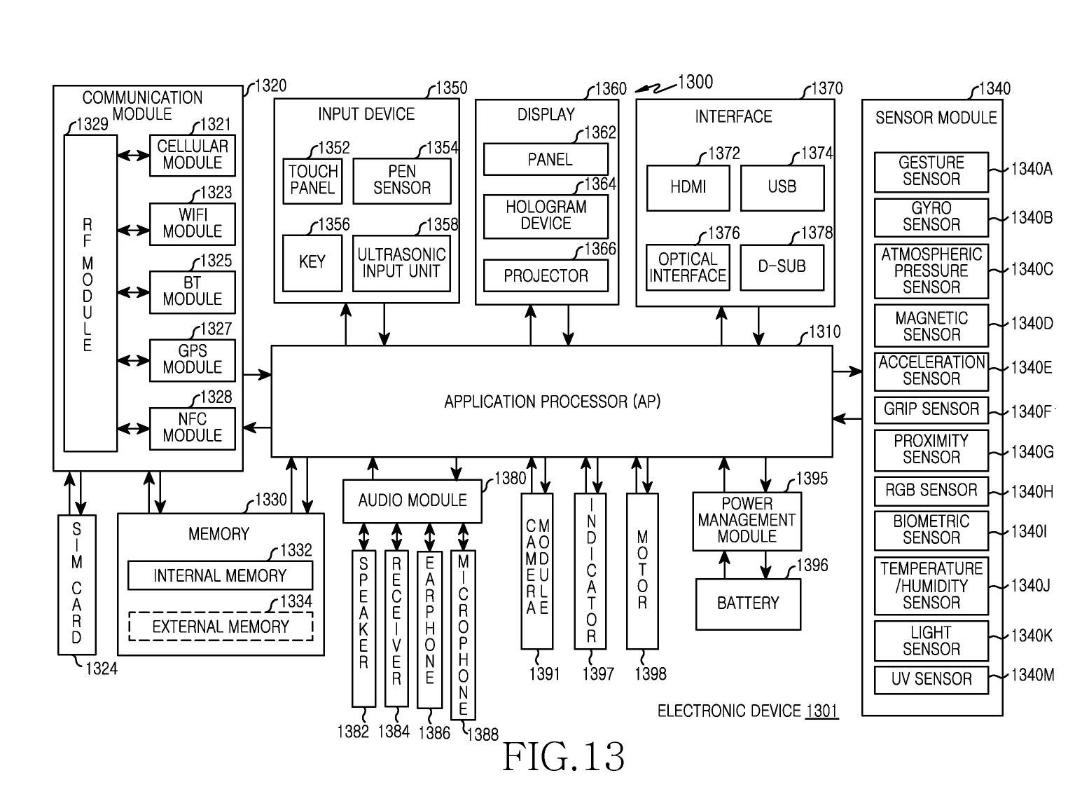

FIG. 13 is a block diagram illustrating an electronic device according to various embodiments of the present disclosure.

Referring to FIG. 13, a block diagram 1300 illustrates an electronic device 1301. The electronic device 1301 may configure, for example, all or a portion of the electronic device 101 illustrated in FIG. 1. Referring to FIG. 13, the electronic device 1301 may include one or more Application Processors (AP) 1310, a communication module 1320, a Subscriber Iidentification Module (SIM) card 1324, a memory 1330, a sensor module 1340, an input unit 1350, a display 1360, an interface 1370, an audio module 1380, a camera module 1391, a power management module 1395, a battery 1396, an indicator 1397, or a motor 1398.

The AP 1310 may drive an OS or an application to control a plurality of hardware or software elements connected to the AP 1310, and perform various data processes including multimedia data and operations. The AP 1310 may be implemented, for example, as a System on Chip (SoC). According to an embodiment of the present disclosure, the AP 1310 may further include a Graphic Pprocessing Unit (GPU) (not shown).

The communication module 1320 (e.g., the communication interface 160) may perform data transmission/reception in communication between the electronic device 1301 (e.g., the electronic device 101) and other electronic devices (e.g., the electronic device 104 or the server 106) connected via a network. According to an embodiment of the present disclosure, the communication module 1320 may include a cellular module 1321, a Wi-Fi module 1323, a BT module 1325, a GPS module 1327, an NFC module 1328, and a Radio Frequency (RF) module 1329.

The cellular module 1321 may provide voice communication, image communication, a short message service, or an Internet service, etc. via a communication network (e.g., LTE, LTE-A, CDMA, WCDMA, UMTS, WiBro, or GSM, etc.). According to various embodiments of the present disclosure, the cellular module 1321 may perform discrimination and authentication of an electronic device within a communication network using, for example, a SIM (e.g., a SIM card 1324). According to an embodiment of the present disclosure, the cellular module 1321 may perform at least a portion of functions that may be provided by the AP 1310. For example, the cellular module 1321 may perform at least a portion of a multimedia control function.

According to an embodiment of the present disclosure, the cellular module 1321 may include a Communication Processor (CP). According to various embodiments of the present disclosure, the cellular module 1321 may be, for example, implemented as an SoC. Although elements such as the cellular module 1321 (e.g., a CP), the memory 1330, or the power management module 1395, and the like are illustrated as elements separated from the AP 1310 in FIG. 13, according to an embodiment of the present disclosure, the AP 1310 may be implemented to include at least a portion (e.g., the cellular module 1321) of the above-described elements.

According to an embodiment of the present disclosure, the AP 1310 or the cellular module 1321 (e.g., a CP) may load an instruction or data received from at least one of a non-volatile memory and other elements connected thereto onto a volatile memory, and process the same. According to various embodiments of the present disclosure, the AP 1310 or the cellular module 1321 may store data received from at least one of other elements or generated by at least one of other elements in a non-volatile memory.

Each of the Wi-Fi module 1323, the BT module 1325, the GPS module 1327, or the NFC module 1328 may include, for example, a processor for processing data transmitted/received via a relevant module. Although the cellular module 1321, the Wi-Fi module 1323, the BT module 1325, the GPS module 1327, or the NFC module 1328 are illustrated as separate blocks in FIG. 13, according to an embodiment of the present disclosure, at least a portion (e.g., two or more elements) of the cellular module 1321, the Wi-Fi module 1323, the BT module 1325, the GPS module 1327, or the NFC module 1328 may be included in one Integrated Circuit (IC) or an IC package. For example, at least a portion (e.g., a CP corresponding to the cellular module 1321 and a Wi-Fi processor corresponding to the Wi-Fi module 1323) of processors corresponding to each of the cellular module 1321, the Wi-Fi module 1323, the BT module 1325, the GPS module 1327, or the NFC module 1328 may be implemented as one SoC.

The RF module 1329 may perform transmission/reception of data, for example, transmission/reception of an RF signal. Although not illustrated, the RF module 1329 may include, for example, a transceiver, a Power Amp Module (PAM), a frequency filter, or a Low Noise Amplifier (LNA) and/or the like. According to various embodiments of the present disclosure, the RF module 1329 may further include a part for transmitting/receiving an electromagnetic wave on a free space in wireless communication, for example, a conductor or a conducting line, and/or the like. Although FIG. 13 illustrates the cellular module 1321, the Wi-Fi module 1323, the BT module 1325, the GPS module 1327, and the NFC module 1328 share one RF module 1329, according to an embodiment of the present disclosure, at least one of the cellular module 1321, the Wi-Fi module 1323, the BT module 1325, the GPS module 1327, or the NFC module 1328 may perform transmission/reception of an RF signal via a separate RF module.

The SIM card 1324 may be a card including a SIM, and may be inserted into a slot formed in a specific position of the electronic device. The SIM card 1324 may include unique identify information (e.g., Integrated Circuit Card IDentifier (ICCID)) or subscriber information (e.g., International Mobile Subscriber Identity (IMSI)).

The memory 1330 (e.g., the memory 130) may include a built-in memory 1332 or an external memory 1334. The built-in memory 1332 may include, for example, at least one of a volatile memory (e.g., Dynamic Random Access Memory (DRAM), Static RAM (SRAM), Synchronous Dynamic RAM (SDRAM)) and a non-volatile memory (e.g., one time programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, NOR flash memory, and/or the like).

According to an embodiment of the present disclosure, the built-in memory 1332 may be a Solid State Drive (SSD). The external memory 1334 may further include a flash drive, for example, Compact Flash (CF), Secure Digital (SD), Micro Secure Digital (Micro-SD), Mini Secure Digital (Mini-SD), extreme Digital (xD), or a memory stick. The external memory 1334 may be functionally connected with the electronic device 1301 via various interfaces. According to an embodiment of the present disclosure, the electronic device 1301 may further include a storage device (or a storage medium) such as a hard drive.

The sensor module 1340 may measure a physical quantity or detect an operation state of the electronic device 1301, and convert the measured or detected information to an electric signal. The sensor module 1340 may include, for example, at least one of a gesture sensor 1340A, a gyro sensor 1340B, an atmospheric pressure sensor 1340C, a magnetic sensor 1340D, an acceleration sensor 1340E, a grip sensor 1340F, a proximity sensor 1340G, a color sensor 1340H (e.g., Red, Green, Blue (RGB) sensor), a living body sensor 1340I, a temperature/humidity sensor 1340J, an illuminance sensor 1340K, or an Ultra Violet (UV) sensor 1340M. Additionally or alternatively, the sensor module 1340 may include, for example, an E-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), or a fingerprint sensor (not shown), and/or the like. The sensor module 1340 may further include a control circuit for controlling at least one sensor belonging thereto.

The input unit 1350 may include a touch panel 1352, a (digital) pen sensor 1354, a key 1356, or an ultrasonic input unit 1358. The touch panel 1352 may recognize a touch input using at least one of capacitive, resistive, IR, or ultrasonic methods. According to various embodiments of the present disclosure, the touch panel 1352 may further include a control circuit. A capacitive touch panel may perform detection by a physical contact or proximity recognition. The touch panel 1352 may further include a tactile layer. In this case, the touch panel 1352 may provide a tactile reaction to a user.

The (digital) pen sensor 1354 may be implemented using, for example, a method which is the same as or similar to receiving a user touch input, or using a separate sheet for detection. The key 1356 may include, for example, a physical button, an optical key or keypad. The ultrasonic input unit 1358 is a unit for recognizing data by detecting a sound wave using a microphone (e.g., a microphone 1388) in the electronic device 1301 via an input tool generating an ultrasonic signal, and enables wireless recognition. According to an embodiment of the present disclosure, the electronic device 1301 may receive a user input from an external device (e.g., a computer or a server) connected to the communication module 1320 using the communication module 1320.

The display 1360 (e.g., the display 150) may include a panel 1362, a hologram device 1364, or a projector 1366. The panel 1362 may be, for example, a Liquid Crystal Display (LCD), or an active-matrix organic light-emitting diode (AM-OLED), and/or the like. The panel 1362 may be implemented, for example, such that it is flexible, transparent, or wearable. The panel 1362 may be configured as one module together with the touch panel 1352. The hologram device 1364 may show a three-dimensional image in the air using interferences of light. The projector 1366 may project light onto a screen to display an image. The screen may be positioned, for example, inside or outside the electronic device 1301. According to an embodiment of the present disclosure, the display 1360 may further include a control circuit for controlling the panel 1362, the hologram device 1364, or the projector 1366.

The interface 1370 may include, for example, a HDMI 1372, a USB 1374, an optical interface 1376, or a D-subminiature (D-sub) 1378. The interface 1370 may be included, for example, in the communication interface 160 illustrated in FIG. 1. Additionally or alternatively, the interface 1370 may include, for example, a Mobile High-definition Link (MHL) interface, a SD card/Multi-Media Card (MMC) interface, or an infrared data association (IrDA) standard interface.

The audio module 1380 may convert a sound and an electric signal in dual directions. At least a partial element of the audio module 1380 may be included, for example, in the I/O interface 140 illustrated in FIG. 1. The audio module 1380 may process sound information input or output via, for example, a speaker 1382, a receiver 1384, an earphone 1386, or a microphone 1388, and/or the like.

The camera module 1391 is a device that may shoot a still image and a moving picture. According to an embodiment of the present disclosure, the camera module 1391 may include one or more image sensors (e.g., a front sensor or a rear sensor), a lens (not shown), an Image Signal Processor (ISP) (not shown), or a flash (not shown) (e.g., an LED or xenon lamp).

The power management module 1395 may manage power of the electronic device 1301. Though not shown, the power management module 1395 may include, for example, a Power Management Integrated Circuit (PMIC), a charger IC, or a battery or a battery or fuel gauge.

The PMIC may be mounted, for example, inside an integrated circuit or an SoC semiconductor. A charging method may be classified into a wired charging method and a wireless charging method. The charging IC may charge a battery and prevent introduction of an overvoltage or an overcurrent from a charger. According to an embodiment of the present disclosure, the charging IC may include a charging IC for at least one of the wired charging method and the wireless charging method. The wireless charging method may be, for example, a magnetic resonance method, a magnetic induction method, or an electromagnetic wave method, and/or the like, and may additionally include an additional circuit for wireless charging, for example, a circuit such as a coil loop, a resonance circuit, a rectifier, and/or the like.

The battery gauge may measure, for example, a remnant of the battery 1396, a voltage, a current, or a temperature while charging. The battery 1396 may store or generate electricity, and supply power to the electronic device 1301 using the stored or generated electricity. The battery 1396 may include, for example, a rechargeable battery or a solar battery.

The indicator 1397 may display a specific state of the electronic device 1301 or a portion thereof (e.g., the AP 1310), for example, a booting state, a message state, a charging state, or the like. The motor 1398 may convert an electric signal to mechanical vibration. Though not shown, the electronic device 1301 may include a processor (e.g., a GPU) for supporting a mobile TV. The processor for supporting the mobile TV may process media data corresponding to standards, for example, such as Digital Multimedia Broadcasting (DMB), Digital Video Broadcasting (DVB), a media flow, and/or the like.

An electronic device according to various embodiments of the present disclosure may include a memory for storing a first OS or a second OS, a first OS management module for controlling the first OS, a second OS management module for controlling the second OS, and a setting module for setting to allow the first OS to be executed in a first mode state, setting to allow the second OS to be executed in a second mode state, displaying a control item executable in the second OS under the first mode state while the first mode state is executed by the first OS, and when receiving an input for the control item, processing to perform a control action corresponding to the control item under the second mode state.

According to various embodiments of the present disclosure, the first OS management module or the second OS management module may be configured to manage setting information for the corresponding first OS or second OS.

According to various embodiments of the present disclosure, the first OS management module or the second OS management module may be configured to manage setting information for an OS using a markup language.

According to various embodiments of the present disclosure, the setting module may generate a control item based on the setting information for the first OS or the second OS, and the control item may include at least one of a control item for the first OS, a control item for the second OS, and a control item controllable in common by the first OS and the second OS.

According to various embodiments of the present disclosure, the setting module may be configured to display a control item for the second OS under the first mode state that outputs an operation related to at least one function being executed by the first OS on a screen.

According to various embodiments of the present disclosure, in case of operating in the first mode state that outputs an operation related to at least one function being executed by an OS operating in the second mode allowing a function to be executed in a background on a screen, the setting module may be configured to display a control item meeting a condition.

According to various embodiments of the present disclosure, in the case according to which the control item corresponding to the input is an item controllable by the first OS and the second OS, the setting module may be configured to change setting of the first OS and the second OS simultaneously.

According to various embodiments of the present disclosure, when displaying a control item, the setting module may be configured to display a function activated in a corresponding OS.

Each of the above-described elements of the electronic device according to the present disclosure may be configured using one or more components, and a name of a relevant element may change depending on a kind of the electronic device. An electronic device according to various embodiments of the present disclosure may include at least one of the above-described elements, and a portion of the elements may be omitted, or additional other elements may be further included. According to various embodiments of the present disclosure, a portion of the elements of the electronic device according to the present disclosure may combine to form one entity and equally perform a function of the relevant elements before the combination.

A terminology “module” used for the present disclosure may mean, for example, a unit including a combination of one or two or more among a hardware, a software, or a firmware. A “module” may be interchangeably used with a terminology such as a unit, a logic, a logical block, a component, or a circuit, etc. A “module” may be a minimum unit of an integrally configured part or a portion thereof. A “module” may be a minimum unit performing one or more functions or a portion thereof. A “module” may be mechanically or electronically implemented. For example, a “module” according to the present disclosure may include at least one of an Application-Specific Integrated Circuit (ASIC) chip, a Field-Programmable Gate Arrays (FPGAs), or a programmable-logic device which are known, or to be developed in the future, and performing certain operations.

According to various embodiments of the present disclosure, at least a portion of an apparatus (e.g., modules or functions thereof) or a method (e.g., operations) according to the present disclosure may be implemented as an instruction stored in a non-transitory computer-readable storage media, for example, in the form of a programming module. An instruction, when executed by one or more processors (e.g., the processor 210), may allow the one or more processors to perform a function corresponding to the instruction. The non-transitory computer-readable storage media may be, for example, the memory 220. At least a portion of a programming module may be implemented (e.g., executed) by, for example, the processor 210. At least a portion of the programming module may include, for example, a module, a program, a routine, sets of instructions, a process, and/or the like for performing one or more functions.

The non-transitory computer-readable storage media may include a hard disk, a magnetic media such as a floppy disk and a magnetic tape, Compact Disc Read Only Memory (CD-ROM), optical media such as DVD, magneto-optical media such as a floptical disk, and a hardware device specially configured for storing and performing a program instruction (e.g., a programming module) such as Read Only Memory (ROM), Random Access Memory (RAM), a flash memory, etc. According to various embodiments of the present disclosure, the program instruction may include not only a machine language code generated by a compiler but also a high-level language code executable by a computer using an interpreter, and/or the like. The above-described hardware device may be configured to operate as one or more software modules in order to perform an operation of the present disclosure, and vice versa.

A module or a programming module according to the present disclosure may include at least one of the above-described elements, omit a portion thereof, or further include additional other elements. Operations performed by a module, a programming module, or other elements according to the present disclosure may be executed in a sequential, parallel, or heuristic method. According to various embodiments of the present disclosure, a portion of the operations may be executed in a different sequence, omitted, or other operations may be added.

According to various embodiments of the present disclosure, a storage medium storing instructions is provided. The instructions, when executed by at least one processor, are set to allow the at least one processor to perform at least one operation. The at least one operation may include driving a plurality of OSs controlling different mode states of an electronic device, setting a first OS among the plurality of OSs such that the first OS is executed in a first mode state, and setting a second OS among the plurality of OSs such that the second OS is executed in a second mode state, while the first mode state is executed by the first OS, displaying a control item executable by the second OS in the first mode state, and when receiving an input for the control item, performing a control action corresponding to the control item under the second mode state.

In a method and an apparatus for controlling an electronic device according to various embodiments of the present disclosure, the first OS operating in the first mode may control the second OS operating in the second mode. In other words, controlling the second OS even without switching the second OS operating in the second mode to the first mode is possible.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling an electronic device, the method comprising:
driving a plurality of Operating Systems (OSs) controlling different mode states of the electronic device;
setting a first OS among the plurality of OSs such that the first OS is executed in a first mode state;
setting a second OS among the plurality of OSs such that the second OS is executed in a second mode state;
while the first mode state is executed by the first OS, displaying a control item executable by the second OS in the first mode state; and
in response to receiving an input relating to the control item, performing a control action corresponding to the control item under the second mode state.

2. The method of claim 1, wherein the first mode state comprises a state that outputs one or more functions being executed via a display, and wherein the second mode state comprises a state that executes a function in a background.

3. The method of claim 1, wherein the first OS comprises a Windows OS, and
wherein the second OS comprises an Android OS.

4. The method of claim 1, further comprising:
displaying, at the first OS, a control item that is executable in the second mode state in the first mode state.

5. The method of claim 1, further comprising:
while the first mode state is executed by the first OS, displaying information for a function activated in the second OS.

6. The method of claim 1, wherein the performing of the control action corresponding to the control item under the second mode state comprises:
performing a control action corresponding to the control item corresponding to the input under even the first mode state.

7. The method of claim 1, wherein the performing of the control action corresponding to the control item under the second mode state comprises:
determining whether the control item corresponding to the input is activated under the first mode state, and
outputting the determination result.

8. The method of claim 1, further comprising, in the case according to which the second OS executed under the second mode state is executed in the first mode state, displaying a control item meeting a condition.

9. The method of claim 1, further comprising:
in response to a control event associated with the second OS,
obtaining setting information for the first OS;
obtaining setting information for the second OS; and
generating the control item.

10. An electronic device comprising:
a memory configured to store a first Operating System (OS) or a second OS;
a first OS management module configured to control the first OS;
a second OS management module configured to control the second OS; and
a setting module configured to set to allow the first OS to be executed in a first mode state, to set to allow the second OS to be executed in a second mode state, to display a control item executable in the second OS under the first mode state while the first mode state is executed by the first OS, and in response to receiving an input relating to the control item, to process to perform a control action corresponding to the control item under the second mode state.

11. The electronic device of claim 10, wherein the first OS management module or the second OS management module is configured to manage setting information for the corresponding first OS or second OS.

12. The electronic device of claim 11, wherein the first OS management module or the second OS management module is configured to manage setting information for an OS using a markup language.

13. The electronic device of claim 11, wherein the setting module generates the control item based on the setting information for the first OS or the second OS, and the control item comprises at least one of a control item for the first OS, a control item for the second OS, and a control item controllable in common by the first OS and the second OS.

14. The electronic device of claim 10, wherein the setting module is configured to display a control item for the second OS under the first mode state that outputs an operation related to at least one function being executed by the first OS on a screen.

15. The electronic device of claim 10, wherein in case of operating in the first mode state that outputs an operation related to at least one function being executed by an OS operating in the second mode allowing a function to be executed in a background on a screen, the setting module is configured to display a control item meeting a condition.

16. The electronic device of claim 10, wherein in the case according to which the control item corresponding to the input is an item controllable by the first OS and the second OS, the setting module is configured to change setting of the first OS and the second OS simultaneously.

17. The electronic device of claim 10, wherein when displaying the control item, the setting module is configured to display a function activated in a corresponding OS.

18. A non-transitory computer-readable recording medium comprising a program recorded thereon, the program executing operations of:
driving a plurality of Operating Systems (OSs) controlling different mode states of an electronic device;
setting a first OS among the plurality of OSs such that the first OS is executed in a first mode state;
setting a second OS among the plurality of OSs such that the second OS is executed in a second mode state;
while the first mode state is executed by the first OS, displaying a control item executable by the second OS in the first mode state; and
in response to receiving an input relating to the control item, performing a control action corresponding to the control item under the second mode state.
